(19) United States
(12) Patent Application Publication
(10) Pub. No.: US 2010/0090599 A1
(43) Pub. Date: Apr. 15, 2010

(54) PLASMA DISPLAY PANEL

(75) Inventors: Seung-Won CHOI, Suwon-si (KR); Tae-Jun Kim, Suwon-si (KR); Woo-Joon Chung, Suwon-si (KR); Goon-Ho Kim, Suwon-si (KR)

Correspondence Address: STEIN MCEWEN, LLP, 1400 EYE STREET, NW, SUITE 300, WASHINGTON, DC, 20005, US

(73) Assignee: Samsung SDI Co., Ltd., Suwon-si (KR)

(21) Appl. No.: 12/575,816

(22) Filed: Oct. 8, 2009

(30) Foreign Application Priority Data
Oct. 9, 2008 (KR) 10-2008-0099173

(51) Int. Cl. H01J 17/49

(52) U.S. Cl. 313/585

(57) ABSTRACT

A plasma display panel that reduces power consumption, improves visual discharge characteristics, and improves dark room contrast includes: sustain electrodes and scan electrodes that comprise transparent electrodes that are disposed having a discharge gap therebetween and bus electrodes formed on the transparent electrodes such that the discharge gap is formed to be nearer one side of a discharge cell and the bus electrode of the scan electrode is disposed near the discharge gap.

### CROSS-REFERENCE TO RELATED APPLICATIONS

This application claims the benefit of Korean Patent Application No. 2008-99173 filed in the Korean Intellectual Property Office on Oct. 9, 2008, the contents of which are incorporated herein by reference.

### BACKGROUND OF THE INVENTION

1. Field of the Invention

Aspects of the present invention relate to a plasma display panel.

2. Description of the Related Art

A plasma display panel (PDP) is a display device that displays images by gas discharge. In other words, the gas discharge generates plasma, the plasma radiates vacuum ultraviolet (VUV) electromagnetic radiation, the vacuum ultraviolet electromagnetic radiation excites a phosphor, and the phosphor generates visible light of red (R), green (G), and blue (B) while in an excited state.

For example, an AC plasma display panel includes barrier ribs that form discharge cells between a rear substrate and a front substrate, address electrodes disposed on the rear substrate to correspond to the discharge cells, and display electrodes (sustain electrodes and scan electrodes) disposed on the front substrate. Each of the sustain electrodes and the scan electrodes is formed of a transparent electrode and an opaque bus electrode.

The discharge cells can be observed from a viewpoint of the display electrode and the barrier rib, i.e., through at least the front substrate. For example, a quadrangular barrier rib structure forms the discharge cell in a quadrangle using a vertical barrier rib member and a horizontal barrier rib member that intersect. In the quadrangular barrier rib structure, the display electrodes are disposed in a discharge space. Therefore, since a wide discharge space is secured, luminance per 1 discharge is high, a discharge margin is large, and a discharge delay is not increased according to a length of time that the plasma display panel is used, but aspect ratio is reduced due to the bus electrode, which decreases the efficiency of visible light emission from the display.

As another example, a double barrier rib structure forms two horizontal barrier ribs to form a non-discharge space between the discharge cells in one direction. In the double barrier rib structure, the display electrode is installed over the barrier rib. In other words, the bus electrode is disposed on the barrier rib. Therefore, the aspect ratio is increased, but the discharge space is reduced, the discharge margin is reduced, the discharge delay is increased according to the length of time that the plasma display panel is used, and the luminance per 1 discharge is low.

In general, in an area where a discharge load is large, such as displaying full white, the double barrier rib structure is advantageous as compared to the quadrangular barrier rib structure in terms of the luminance efficiency, but the double barrier rib structure is disadvantageous as compared to the quadrangular barrier rib structure in a 10 to 30% load, i.e., a load corresponding to displaying a moving picture. In the double barrier rib structure, the number of sustain pulses should be increased to generate the same luminance such that the reactive power consumption is increased.

The above information disclosed in this Background section is only for enhancement of understanding of the background of the invention, and therefore, it may contain information that does not form the prior art that is already known in this country to a person of ordinary skill in the art.

### SUMMARY OF THE INVENTION

Aspects of the present invention provide a plasma display panel that improves efficiency by reducing power consumption, that is, reactive power consumption. Aspects of the present invention also provide a plasma display panel that improves visual discharge characteristics and dark room contrast by reducing black luminance. Aspects of the present invention provide a plasma display panel that improves bright room contrast by symmetrically disposing bus electrodes in a discharge cell and including a black matrix.

A plasma display panel according to aspects of the present invention includes: a front substrate and a rear substrate disposed to face each other; barrier ribs that include first barrier rib members extending in a first direction between both substrates and second barrier rib members extending in a second direction that intersects with the first direction, the first and second barrier rib members together forming discharge cells between the front and rear barrier rib members; address electrodes disposed on the rear substrate and extending in the first direction between adjacent first barrier rib members; and sustain electrodes and scan electrodes disposed on the front substrate extending in the second direction between adjacent first barrier rib members, each of the sustain electrodes and the scan electrodes comprising a transparent electrode, the transparent electrodes being disposed to have a discharge gap between the transparent electrode of the sustain electrodes and the transparent electrode of the scan electrode and a bus electrode disposed on each transparent electrode, wherein the discharge gap is formed nearer one of the adjacent second barrier rib members and the bus electrode of the scan electrode may be disposed nearer the discharge gap than the bus electrode of the sustain electrode.

According to aspects of the present invention, the transparent electrode of the sustain electrode has a first width in the first direction, the transparent electrode of the scan electrode has a second width in the first direction, and the second width may be less than the first width.

According to aspects of the present invention, the transparent electrode of the sustain electrode has a first area within each discharge cell, the transparent electrode of the scan electrode has a second area within each discharge cell, and the second area may be smaller than the first area.

According to aspects of the present invention, the bus electrode of the sustain electrode may be disposed away from the discharge gap.

According to aspects of the present invention, the sustain electrodes and the scan electrodes in adjacent discharge cells may be arranged in a first arrangement having an order of scan electrode, sustain electrode, sustain electrode, and scan electrode, or the sustain electrodes and the scan electrodes in adjacent discharge cells are arranged in a second arrangement having an order of sustain electrode, scan electrode, scan electrode, and sustain electrode in the adjacent discharge cells being adjacent in the first direction.

According to aspects of the present invention, the plasma display panel may further include a black matrix formed on the front substrate, wherein the black matrix may include first black members disposed between the first barrier rib members and the front substrate, and second black members disposed between the second barrier rib members and the front substrate.

According to aspects of the present invention, the bus electrodes of the pair of sustain electrodes adjacent to each other in the first direction and the second black member disposed between the bus electrodes, and the bus electrodes of the pair of scan electrodes adjacent to each other in the first direction and the second black members disposed between the bus electrodes of the pair of scan electrodes are symmetrical.

According to aspects of the present invention, a first distance in the first direction between the second black member of one side of one of the discharge cells and the bus electrode of the sustain electrode may be the same as a second distance in the first direction between the second black member of the other side of the one of the discharge cells and the bus electrode of the scan electrode.

According to aspects of the present invention, a third distance in the first direction between the bus electrode of the sustain electrode and the bus electrode of the scan electrode in the one of the discharge cells may be larger than each of the first distance and the second distance.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is an exploded perspective view of a plasma display panel according to an exemplary embodiment of the present invention;

FIG. 2 is a cross-section view taken along the line II-II of FIG. 1;

FIG. 3 is a plan view showing an arrangement relationship of a barrier rib and a display electrode of FIG. 1;

FIG. 4 is a graph showing a ratio of reactive power consumption according to an arrangement of sustain electrodes and scan electrodes;

FIG. 5 is a graph showing address discharge delay characteristics according to a position of a bus electrode on a scan electrode;

FIG. 6 is a graph showing an address discharge voltage according to an area of a transparent electrode in a scan electrode; and

FIG. 7 is a graph showing a decrease of black luminance according to an area of a transparent electrode and a position of a bus electrode on a scan electrode.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

When it is described that a first part is “connected” to a second part, the first and second parts can be directly electrically connected (no intervening elements) or can be indirectly electrically connected (intervening elements may be present). Herein, when a first element is referred to as being formed or disposed “on” a second element, the first element can be disposed directly on the second element, or one or more other elements may be disposed therebetween. When a first element is referred to as being formed or disposed “directly on” a second element, no other elements are disposed therebetween. In the drawings, the lengths or thicknesses of layers and regions are exaggerated for clarity.

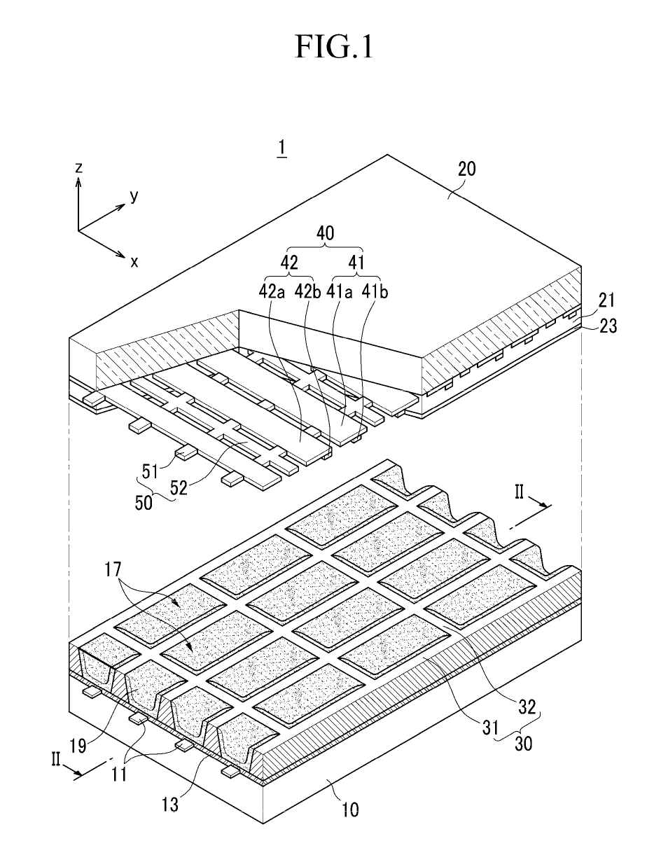

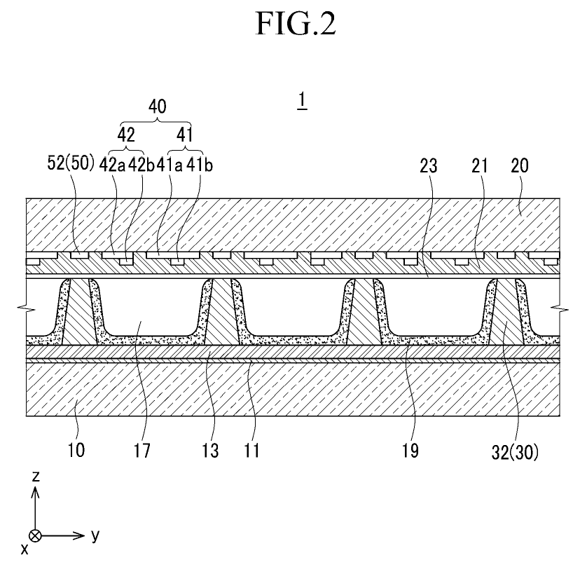

FIG. 1 is an exploded perspective view of a plasma display panel according to an exemplary embodiment of the present invention, and FIG. 2 is a cross-sectional view taken along the line II-II of FIG. 1. Referring to FIGS. 1 and 2, a plasma display panel 1 according to an exemplary embodiment includes a rear substrate 10 and a front substrate 20 that face each other while maintaining a gap therebetween and includes barrier ribs 30 that are disposed between both substrates 10 and 20.

The barrier ribs 30 partition a space set between the rear substrate 10 and the front substrate 20 to form a plurality of discharge cells 17. The discharge cell 17 is provided with a phosphor layer 19 disposed therein and is filled with a discharge gas (for example, a mixed gas including Neon (Ne), Xenon (Xe), etc.).

The discharge gas generates vacuum ultraviolet electromagnetic radiation by a gas discharge, the phosphor layer 19 is excited by the vacuum ultraviolet electromagnetic radiation and then stabilized to discharge visible light of red (R), green (G), and blue (B).

In order to generate the gas discharge, an address electrode 11 and a display electrode 40 are disposed in the discharge cell 17. As one example, the address electrode 11 is formed to be extended along a first direction (hereinafter, referred to as “y-axis direction”) on an inner surface (or internal surface) of the rear substrate 10 and continuously corresponds to the discharge cells 17 adjacent to each other in the y-axis direction, i.e., the address electrode 11 is disposed on the rear substrate 10 between adjacent barrier ribs 31 that also extend in the y-axis direction.

The plurality of address electrodes 11 are disposed on the substrate 10 to be parallel so as to correspond to the discharge cells 17 disposed adjacently in a second direction (hereinafter, referred to as “x-axis direction,” which intersects the y-axis direction), i.e., the plurality of address electrodes 11 are disposed adjacently in the x-axis direction.

A first dielectric layer 13 covers the inner surface of the rear substrate 10 and the address electrodes 11. The first dielectric layer 13 prevents positive ions or electrons from directly colliding with the address electrodes 11 upon discharging to protect the address electrodes 11 from the gas discharge. Further, the first dielectric layer 13 allows for wall charges to be formed and accumulated, thereby making it possible to generate the address discharge even by a low voltage. The address electrode 11 is disposed on the rear substrate 10 such that it does not hinder the transmission of visible light through the front substrate 20. The address electrode 11 may be formed of an opaque electrode, that is, a metal electrode, such as silver (Ag), having excellent conductivity.

The barrier ribs 30 are disposed on the first dielectric layer 13 of the rear substrate 10 to partition a space between the rear and front substrates 10 and 20, thereby forming the discharge cells 17. For example, the barrier ribs 30 include first barrier rib members 31 that are formed to be extended in the y-axis direction and second barrier rib members 32 that are formed to be extended in the x-axis direction. The second barrier rib members 32 may be formed between the first barrier rib members 31. In other words, the first barrier rib members 31 partition the discharge cells 17 adjacent to each other in the x-axis direction, and the second barrier rib member 32 partitions the discharge cells 17 adjacent to each other in the y-axis direction. Therefore, a quadrangular barrier rib structure allows the discharge cells 17 to be formed in a matrix structure.

The phosphor layers 19 may be formed by applying phosphor paste on the side surfaces of the first barrier rib members 31 and the second barrier members 32 and the surface of the first dielectric layer 13 that is established by the first barrier rib members 31 and the second barrier rib members 32, i.e., the area of the first dielectric layer 13 between the first and second barrier rib members, and drying and firing the applied phosphor paste. The phosphor layers 19 may be formed of a phosphor that generates a same color of visible light in the discharge cells 17 formed along the y-axis direction. The phosphor layers 19 are formed of phosphors that generate visible light of red (R), green (G), and blue (B) to each of the discharge cells 17. The red (R), green (G), and blue (B) phosphor layers 19 may be repetitively, i.e., sequentially, disposed along the x-axis direction.

The display electrodes 40 include the sustain electrodes 41 and the scan electrodes 42 that are disposed in parallel in the discharge cell 17, i.e., between adjacent second barrier rib members 32. The sustain electrodes 41 and the scan electrodes 42 are formed on the inner surface of the front substrate 20 to correspond to the discharge cells 17. The sustain electrodes 41 and the scan electrodes 42 form a surface discharge structure corresponding to the discharge cells 17 to generate the gas discharge in each of the discharge cells 17.

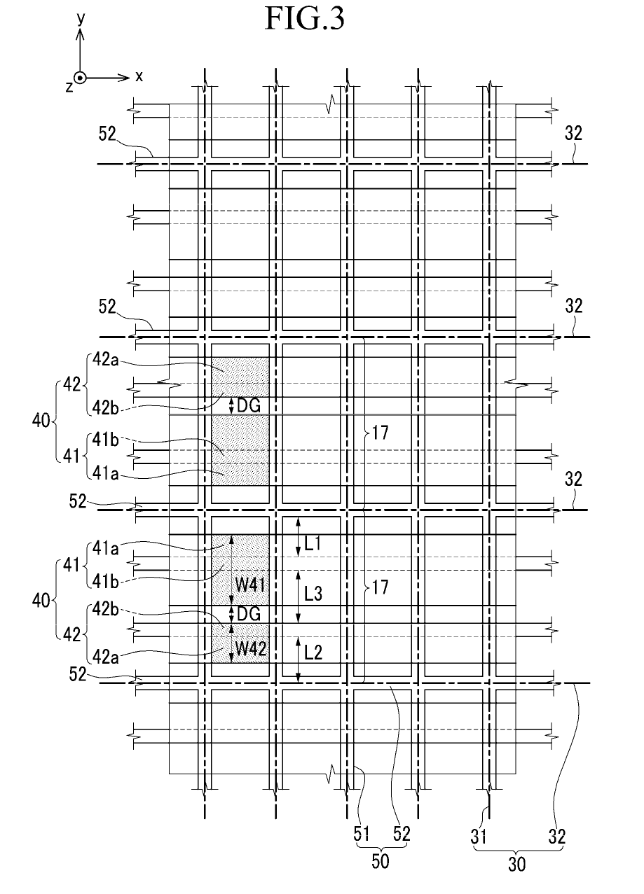

FIG. 3 is a plan view showing an arrangement relationship of a barrier rib and a display electrode. Referring to FIG. 3, the sustain electrodes 41 and the scan electrodes 42, which are parallel, are extended along the x-axis direction intersecting the address electrodes 11 (not shown in FIG. 3).

The sustain electrodes 41 and the scan electrode 42 each include transparent electrodes 41a and 42a that generate the discharge and bus electrodes 41b and 42b that apply voltage signals to the transparent electrodes 41a and 42a. The transparent electrodes 41a and 42a form a discharge gap DG in the discharge cell 17 and is made of a transparent material (for example, indium tin oxide (ITO)) to secure an aperature ratio of the discharge cell 17. The bus electrodes 41b and 42b are formed on the transparent electrodes 41a and 42a to apply the voltage signals to the transparent electrodes 41a and 42a and are made of a metallic material to secure excellent electrical conductivity. For example, the bus electrodes 41b and 42b may be formed of at least two-layers including a black layer (not shown) and a white layer (not shown), wherein the black layer is exhibited to the outside through the front substrate 20. Therefore, viewed from the outside of the front substrate 20, the bus electrodes 41b and 42b form a black portion.

Hereinafter, the arrangement and area relationship between the sustain electrodes 41 and the scan electrodes 42 for the discharge cell 17 will be described. In detail, the arrangement relationship between the transparent electrodes 41a and 42a and the bus electrodes 41b and 42b and the area relationship between the transparent electrodes 41a and 42a for the discharge cell 17 will be described.

In the unit discharge cell 17, the discharge gap DG is not formed at the center of the discharge cell 17 in the y-axis direction, but is formed to be nearer to one side in the y-axis direction. For example, each of the transparent electrodes 41a and 42a is formed from the discharge gap DG to a side adjacent to the second barrier rib member 32. Under the condition, the transparent electrode 41a of the sustain electrode 41 has a first width W41 set in the y-axis direction and the transparent electrode 42a of the scan electrode 42 has a second width W42 set in the y-axis direction. And, the second width W42 is smaller than the first width W41. Therefore, the discharge gap DG may be disposed to be more inclined to the second barrier rib member 32 adjacent to the scan electrode 42 than the second barrier rib member 32 adjacent to the sustain electrode 42.

Stated differently, each of the transparent electrodes 41a and 42a is formed from the discharge gap DG to a side adjacent to the second barrier rib member 32 and is a stripe type that is lengthily formed in the x-axis direction. Under these conditions, the transparent electrode of the sustain electrode 41 forms the first area A41 at one side of the discharge cell 17 in y-axis direction and the transparent electrode 42a of the scan electrode 42 forms the second area A42 at the other side of the discharge cell 17 in the y-axis direction. Therefore, the second area A42 of the transparent electrode 42a is smaller than the first area 41a of the transparent electrode 41a by a difference between the first and second widths W41 and W42.

As such, the transparent electrode 42a of the scan electrode 42 is formed having a smaller width or a smaller area than the transparent electrode 41a of the sustain electrode 41, such that the area facing the address electrode 11 is reduced. The discharge can be easily diffused from the bus electrode 42b adjacent to the discharge gap to one end of the transparent electrode 42a adjacent to the second barrier rib 32 by reducing the width or area of the transparent electrode 42a of the scan electrode 42. And, even if the area of the transparent electrodes 42a of the scan electrode 42 is reduced, the bus electrode 42b is positioned near or adjacent to the discharge gap, making it possible to improve the voltage margin of the address discharge. Further, when the transparent electrode 42a of the scan electrode 42 is reduced in area or width, the light emitted upon resetting to discharge cells 17 is reduced thereby reducing the black luminance at the side of the scan electrode 42. Therefore, the visual discharge characteristics are improved and the dark room contrast is improved.

Further, the transparent electrode may be formed of a protrusion electrode independently corresponding to the discharge cell. In this case, the second area of the transparent electrode is formed to be smaller than the first area of the transparent electrode, making it possible to obtain the same or similar effect as the stripe type described above.

In the discharge cell 17, the bus electrode 41b of the sustain electrode 41 is disposed on the transparent electrode 41a at a distance from the discharge gap DG. And, since the transparent electrode 41a is positioned in the discharge cell 17, the bus electrode 41b is positioned in the discharge cell 17 not directly adjacent to the second barrier rib member 32, i.e., not directly next to the discharge gap DG but not directly next to the second barrier rib member 32.

The bus electrode 42b of the scan electrode 42 is disposed on the transparent electrode 42a in the vicinity of or adjacent to the discharge gap DG in the discharge cell 17. And, since the transparent electrode 42a is positioned in the discharge cell 17, the bus electrode 42b is positioned in the discharge cell 17. The bus electrode 42b of the scan electrode 42 is disposed to nearer the discharge gap DG than the bus electrode 41b of the sustain electrode 41. The bus electrode 42b of the scan electrode 42 is disposed near the discharge gap DG to prevent a voltage drop of the transparent electrode 42a such that the address discharge and the sustain discharge can be achieved by a low voltage. Therefore, the efficiency of the plasma display panel 1 is improved.

Next, a pair of the discharge cells 17 connected to each other in the y direction will be described. Reviewing the arrangement relationship between the sustain electrode 41 and the scan electrode 42 for the discharge cell 17, the discharge cell 17 is formed to align with a pair of display electrodes 40 connected to each other in the y-axis direction wherein each pair is repeated along the y-axis direction, i.e., a sustain electrode 41 and a scan electrode 42 make up the pair of display electrodes 40, which extend in the x-axis direction, are adjacent to similar pairs of display electrodes 40 in the y-axis direction, and correspond to respective discharge cells 17 adjacent in the y-axis direction.

In the pair of discharge cells 17, the sustain electrode 41 and the scan electrode 42 are disposed in a first arrangement or a second arrangement. For example, in the first arrangement, the sustain electrodes 41 are disposed in the middle of the pair of display electrodes 40 in the respective discharge cells 17, that is, the arrangement of the scan electrode 42, sustain electrode 41, sustain electrode 41, and scan electrode 42. In the second arrangement, the scan electrodes 42 are disposed in the middle of the pair of display electrodes 40 in the respective discharge cells 17, that is, the arrangement of the sustain electrode 41, scan electrode 42, scan electrode 42 and sustain electrode 41.

In the pair of discharge cells 17 adjacent to each other in y-axis direction, since the pair of sustain electrodes 41 is repetitively or adjacently disposed or the pair of scan electrodes 42 is repetitively or adjacently disposed, capacitance between the adjacent discharge cells 17 is reduced. Therefore, the reactive power consumption is reduced and the efficiency of the plasma display panel 1 is also improved.

Meanwhile, a black matrix 50 does not hinder the transmission of visible light and is disposed the front substrate 20 to correspond to the barrier ribs 30, that is, the black matrix is disposed in a non-emitting area so as to absorb external light. The black matrix 50 includes first black members 51 and second black members 52. The first black members 51 are formed to correspond to the first barrier rib members 31, and the second black members 52 are formed to correspond to the second barrier rib members 32. The second black members 52 intersect with the first black members 51.

The second black members 52 is formed to extend in the x-axis direction, and the second black members 52 can be formed on the inner surface, or internal surface of the front substrate 20. The first black members 51 intersect with the sustain electrodes 41 and the scan electrodes 42 depending on the process, such that it can be formed on the inner surface of the front substrate 20 or above or below the display electrodes 40. Further, either of the first black members or the second black members 52 may not be formed.

The black matrix 50 is disposed in the non-light emitting area to form a black portion together with the bus electrodes 41b and 42b without decreasing luminance and to absorb external light, thereby improving the bright room contrast.

Hereinafter, reflecting the second black member 52, the arrangement relationship between the bus electrodes 41b and 42b for the discharge cell 17, will be described. Each second black member 52 is disposed at both sides of the discharge cells 17 to form a pair of adjacent second black members 52. The second black members 52 of one side among the pair of second black members 52 is disposed between the bus electrodes 41b of the pair of sustain electrodes 41 adjacent to each other in the y-axis direction and the other second black member 52 among the pair of second black members 52 is disposed between the bus electrodes 42b of the pair of scan electrodes 42.

Further, the second black member 52 of one side and the bus electrodes 41b of the pair of sustain electrodes 41 disposed at both sides thereof and the other second black member 52 among the pair of second black members 52 and the bus electrodes 42b of the pair of scan electrodes 42 disposed at both sides thereof are formed in a symmetrical structure. Stated differently, in the unit discharge cell 17, the second black member 52 of one side and the bus electrode 41b of the sustain electrode 41 are set a first distance L1 in the y-axis direction and the other second black member 52 of the other side and the bus electrode 42b of the scan electrode 42 set a second distance L2 in the y-axis direction. In spite of the difference between the widths and area sizes of the transparent electrodes 41a and 42a, the first distance L1 is equal to the second distance L2, i.e., L1=L2.

And, in the same discharge cell 17, the bus electrode 41b of the sustain electrode 41 and the bus electrode 42b of the scan electrode 42 set a third distance L3 along the y-axis direction. The third distance L3 is larger than the first distance L1 and the second distance L2, respectively, i.e., L3>L1, and L3>L2. As such, the second black members 52 and the bus electrodes 41b and 42b that form the black portion are symmetrical with each other in the discharge cell 17, i.e., the bus electrodes 41b and 42b are equidistant from respective nearest second black members 52, such that the black luminance is uniform at both sides of the discharge cell 17 in the y-axis direction. Therefore, the visual discharge characteristics are improved and the dark room contrast is also improved.

Referring back to FIGS. 1 and 2, the second dielectric layer 21 covers the inner surface of the front substrate 20, the sustain electrodes 41, the scan electrodes 42, and the black matrix 50. The second dielectric layer 21 protects the sustain electrodes 41 and the scan electrodes 42 from positive ions or electrons generated upon discharging and allows for wall charges for discharging to be formed and accumulated.

A protective layer 23 covers the second dielectric layer 21. For example, the protective layer 23 is made of transparent MgO that transmits visible light and protects the second dielectric layer 21 from positive ions or electrons generated upon discharging and increase secondary electron emission coefficient upon discharging.

For example, describing the driving of the plasma display panel 1, a reset discharge is generated by a reset pulse applied to the scan electrodes 42 in a reset period. In a scan period subsequent to the reset period, the address discharge is generated by a scan pulse applied to the scan electrodes 42 and an address pulse applied to the address electrodes 11. Thereafter, in the sustain period, the sustain discharge is generated by a sustain pulse applied to the sustain electrodes 41 and the scan electrodes 42. The sustain electrodes 41 and the scan electrodes 42 perform apply the sustain pulse required for the sustain discharge. The scan electrodes 42 apply the reset pulse and the scan pulse. The address electrodes 11 apply the address pulse. Since the roles of the sustain electrodes 41, the scan electrodes 42, and the address electrode 11 may be different according to a voltage waveform applied to each of them, aspects are not limited to the above description.

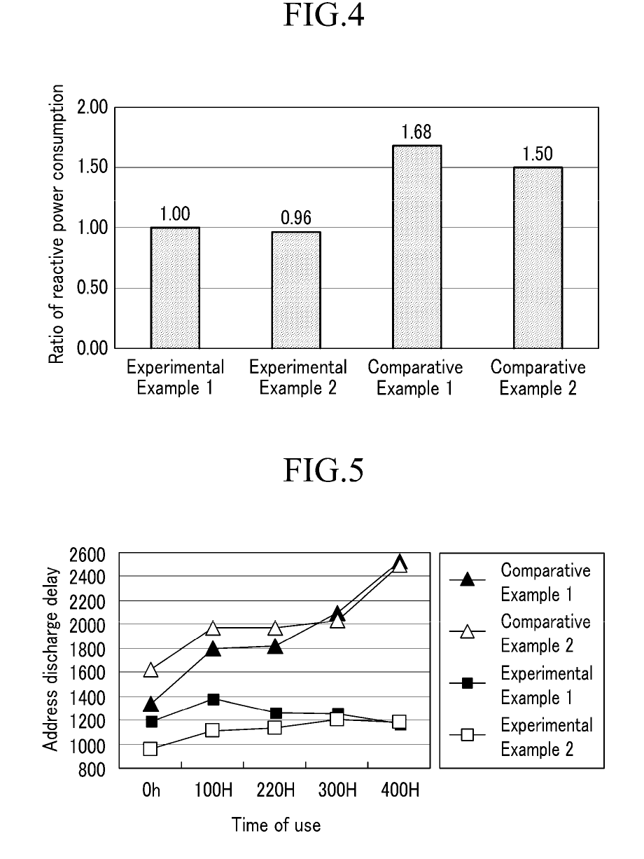

FIG. 4 is a graph showing a ratio of reactive power consumption according to the arrangement of the electrodes. Referring to FIG. 4, Experimental Example 1 and Experimental Example 2 are formed according to aspects of the present invention, that is, the scan electrodes 42 and the sustain electrodes 41 are arranged in adjacent discharge cells 17 as follows: scan electrode 42, sustain electrode 41, sustain electrode 41, and scan electrode 42 in the quadrangular barrier rib structure; and Comparative Example 1 and Comparative Example 2 are formed having the scan electrodes 42 and the sustain electrodes 41 arranged in adjacent discharge cells 17 as follows: scan electrode 42, sustain electrode 41, scan electrode 42, and sustain electrode 41 in the quadrangular barrier rib structure.

Assuming that the reactive power consumption ratio of Experimental Examples 1 and 2 was approximately 1, it is shown that the reactive power consumption of the Comparative Examples 1 and 2 was 1.5 or more. Therefore, it can be appreciated that the reactive power consumption was reduced by about 30% in the Experimental Examples 1 and 2 than in the Comparative Examples 1 and 2. The efficiency of the PDP was improved according to the decrease of the reactive power consumption.

FIG. 5 is a graph showing address discharge delay characteristics according to a position of a bus electrode in a scan electrode. Referring to FIG. 5, when the plasma display panel is used for a longer time, the Comparative Examples 1 and 2 show that the address discharge delay was slowly increased an then suddenly increased, while the Experimental Examples 1 and 2 show that the constant address discharge delay was maintained.

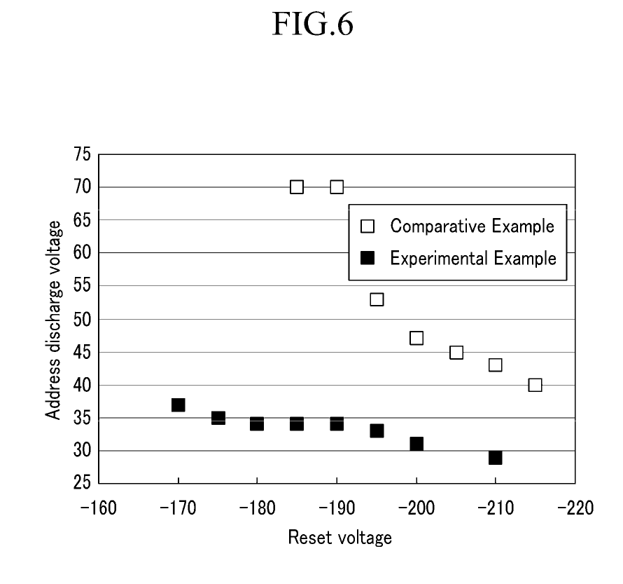

FIG. 6 is a graph showing an address discharge voltage according to an area of a transparent electrode in a scan electrode. Referring to FIG. 6, the Experimental Example showed that the fluctuation of the address discharge voltage is not large in spite of the change of the reset voltage, while the Comparative Example showed that the fluctuation of the address discharge voltage is large according to the change of the reset voltage. Therefore, the Experimental Example has a low voltage address discharge as compared to the Comparative Example such that the efficiency of the plasma display panel 1 is improved and the visual discharge characteristics and the dark room contrast are improved by the decrease of the light emitted during a reset period.

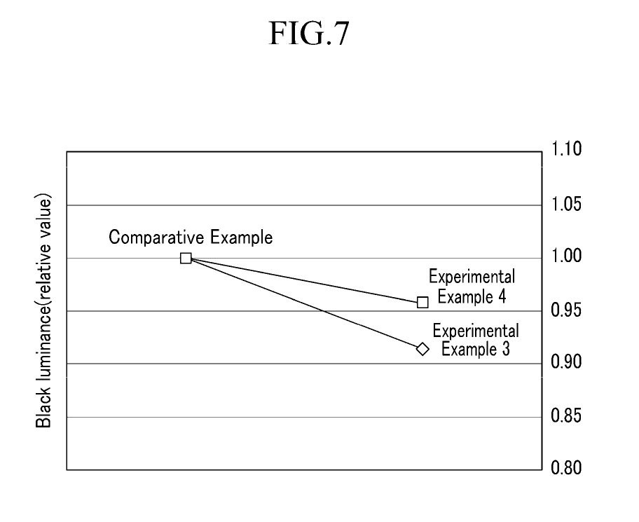

FIG. 7 is a graph showing a decrease of black luminance according to an area of a transparent electrode and a position of a bus electrode. Referring to FIG. 7, Experimental Example 3 was formed such that the second area A2 of the transparent electrode 42a of the scan electrode 42 was smaller than the first area 41 of the transparent electrode 41a of the sustain electrode 41 and showed that the black luminance was remarkably decreased as compared to the Comparative Example.

In Experimental Example 4, the bus electrode 42b of the scan electrode 42 was formed at a side of the transparent electrode 42a adjacent to the discharge gap DG, and showed that the black luminance was decreased as compared to the Comparative Example. The Comparative Example was formed such that the areas of the sustain and scan electrodes were equal, and the distances between the discharge gap and the bus electrodes were also equal.

Assuming that the black luminance of the Comparative Example is 1, the black luminance of Experimental Example 3 was 0.92, such that it can be appreciated that the black luminance was decreased by about 8% as compared to the Comparative Example, and the black luminance of Experimental Example 4 was 0.96, such that it can be appreciated that the black luminance was decreased by about 4% as compared to the Comparative Example. Further, it can be appreciated that the black luminance was further decreased in Experimental Example 3 than in Experimental Example 4.

As such, according to aspects of the present invention, in the pair of discharge cells adjacent to each other in the y-axis direction, when the display electrodes are arranged in the scan electrode, the sustain electrode, the sustain electrode, and the scan electrode arrangement according to aspects of the present invention, the reactive power consumption is reduced. Therefore, the efficiency of the PDP is improved

In the unit discharge cell, when the bus electrode of the sustain electrode is disposed at a distance from the discharge gap and the bus electrode of the scan electrode is disposed near the discharge gap according to aspects of the present invention, a low driving voltage can be achieved. Therefore, the efficiency of the PDP is further improved

When the transparent electrode of the scan electrode is formed to have a smaller width (or smaller area) than the transparent electrode of the sustain electrode according to aspects of the present invention, the voltage margin is improved and the light emitted externally upon reset is reduced so as to decrease the black luminance. Therefore, the visual discharge characteristics and the dark room contrast are improved.

In the unit discharge cell, when each bus electrode of the sustain electrode and the scan electrode is symmetrical according to aspects of the present invention, the visual discharge characteristics and the dark room contrast are improved.

When each bus electrode of the sustain electrode and the scan electrode absorbs the external light together with the black matrix above the barrier rib according to aspects of the present invention, the bright room contrast is improved.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A plasma display panel, comprising:
a front substrate and a rear substrate disposed to face each other;
barrier ribs comprising:
first barrier rib members extending in a first direction between both substrates, and
second barrier rib members extending in a second direction that intersects the first direction, the first and second barrier rib members together forming discharge cells between the front and rear substrates;
address electrodes disposed on the rear substrate and extending in the first direction between adjacent first barrier rib members; and
sustain electrodes and scan electrodes disposed on the front substrate extending in the second direction, one of the sustain electrodes and one of the scan electrodes being paired between adjacent first barrier rib members, each of the sustain electrodes and the scan electrodes comprising:
a transparent electrode, the transparent electrodes of the paired sustain and scan electrodes being disposed to have a discharge gap therebetween, and
a bus electrode disposed on each transparent electrode,
wherein the discharge gap is formed nearer one of the adjacent second barrier rib members, and
wherein the bus electrode of the scan electrode is disposed nearer the discharge gap than the bus electrode of the sustain electrode.

2. The plasma display panel of claim 1, wherein:
the transparent electrode of the sustain electrode has a first width in the first direction,
the transparent electrode of the scan electrode has a second width in the first direction, and
the second width is less than the first width.

3. The plasma display panel of claim 1, wherein:
the transparent electrode of each of the sustain electrodes has a first area within each discharge cell,
the transparent electrode of each of the scan electrodes has a second area within each discharge cell, and
the second area is smaller than the first area.

4. The plasma display panel of claim 3, wherein:
the bus electrode of each of the sustain electrodes is disposed away from the discharge gap.

5. The plasma display panel of claim 3, wherein:
the bus electrode of each of the sustain electrodes is disposed farther away from the discharge gap than the bus electrode of each of the scan electrodes.

6. The plasma display panel of claim 1, wherein the bus electrode of the scan electrode is disposed at an edge of the transparent electrode of the scan electrode adjacent to the discharge gap.

7. The plasma display panel of claim 1, wherein:
the paired sustain electrodes and the scan electrodes in adjacent discharge cells are arranged in a first arrangement having an order of scan electrode, sustain electrode, sustain electrode, and scan electrode, or the paired sustain electrodes and the scan electrodes in adjacent discharge cells are arranged in a second arrangement having an order of sustain electrode, scan electrode, scan electrode, and sustain electrode, the adjacent discharge cells being adjacent in the first direction.

8. The plasma display panel of claim 7, further comprising:
a black matrix formed on the front substrate, the black matrix comprising:
first black members disposed between the first barrier rib members and the front substrate; and
second black members disposed between the second barrier rib members and the front substrate.

9. The plasma display panel of claim 8, wherein:
the bus electrodes of the sustain electrodes adjacent to each other in the first direction and the second black member disposed between the bus electrodes are symmetrical about the bus electrodes of the scan electrodes adjacent to each other in the first direction and the second black member disposed between the bus electrodes of the pair of scan electrodes.

10. The plasma display panel of claim 9, wherein:
a first distance in the first direction between the second black member of one side of one of the discharge cells and the bus electrode of the sustain electrode is the same as a second distance in the first direction between the second black member of the other side of the one of the discharge cells and the bus electrode of the scan electrode.

11. The plasma display panel of claim 10, wherein:
a third distance in the first direction between the bus electrode of the sustain electrode and the bus electrode of the scan electrode in the one of the discharge cells is larger than each of the first distance and the second distance.
